(19) United States
(12) Patent Application Publication
(10) Pub. No.: US 2005/0159530 A1
(43) Pub. Date: Jul. 21, 2005

(54) Core-shell latex polymer comprising a crystalline polymer and method of preparing a core-shell latex polymer

(75) Inventors: Jun-young Lee, Seongnam-si (KR); Kyung-yol Yon, Seongnam-si (KR); Sang-woo Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/993,446

(22) Filed: Nov. 22, 2004

(30) Foreign Application Priority Data
Jan. 20, 2004 (KR) 2004-4267

(51) Int. Cl. C08F 2/16

(52) U.S. Cl. 524/458

(57) ABSTRACT

Core-shell latex polymer is produced that includes a crystalline polymer. The core-shell latex polymer includes the crystalline polymer, a base monomer, a dispersing agent, an initiator and distilled water. The crystalline polymer serves as the core of the resulting polymer particle. The core-shell latex polymer including the crystalline polymer having a low melting point is used in a toner. A latex polymer including a releasing agent is easily prepared without using high temperatures or a high speed dispersing device. The crystalline polymer efficiently coagulates with other particles in the toner. In addition, the fixing temperature may be reduced when the toner is used in an image forming device.

This application claims the benefit under 35 U.S.C. § 119 from Korean Patent Application No. 2004-4267, filed on Jan. 20, 2004, the entire content of which is incorporated herein by reference.

### BACKGROUND OF THE INVENTION

1. Field of the Invention

The present invention relates to a latex polymer. More particularly, the present invention relates to a latex polymer with a shape of a core-shell including a crystalline polymer, which can be used in a toner composition for an electrophotographic image-forming device.

2. Description of the Related Art

In electrophotographic image forming devices, photosensitive materials are electrically charged and then exposed to an image forming light source to form electrostatic latent images. Images are developed by a toner or ink using a developing voltage. The images developed by the toner are transferred onto a recording medium such as a paper to fix and form images. Examples of the electrophotographic image forming devices include copy machines, printers, and facsimile machines.

Toners used in the electrophotographic image forming devices generally include a coloring agent, a binder resin and a charge control agent. The toners may further include other additives having desired functions.

The coloring agent generally exhibits color to a fixed image. A dye based coloring agent or a pigment based coloring agent may be used as the coloring agent. Examples of coloring agents include carbon black, aniline blue, phthalocyanine blue, phthalocyanine green, rhodamine dye or pigment, chromium yellow, quinacridone, benzidine yellow, rose bengal, triallylmethane, monoazo dye or pigment, disazo dye or pigment, and the like.

The binder resin may be present in the toner in an amount of about 90% by weight. The binder resin fixes toner particles onto the recording medium. Polymers used as the binder resin include a latex polymer having a colloidal gel phase with two components that are dispersed as particles. The latex polymer preferably includes resin particles dispersed in an aqueous medium. The latex polymer includes ionic surfactants, and preferably anionic surfactants. Alternatively, the latex polymer may include non-ionic surfactants.

Examples of the resin particles used in the latex include poly(styrene butadiene), poly(para-methylstyrene butadiene), poly(metha-methylstyrene butadiene), poly(α-methylstyrene butadiene), poly(methylmethacrylate butadiene), poly(ethylmethacrylate butadiene), poly(propylmethacrylate butadiene), poly(butylmethacrylate butadiene), poly(methylacrylate butadiene), poly(ethylacrylate butadiene), poly(styrene isoprene), poly(para-methylstyrene isoprene), poly(metha-methylstyrene isoprene), poly(α-methylstyrene isoprene), poly(methylmethacrylate isoprene), poly(ethylmethacrylate butadiene), poly(propylacrylate butadiene), poly(butylacrylate butadiene), poly(styrene isoprene), poly(para-methylstyrene isoprene), poly(metha-methylstyrene isoprene), poly(methylmethacrylate isoprene), poly(ethylmethacrylate isoprene), poly(propylmethacrylate isoprene), poly(butylmethacrylate isoprene), poly(methylacrylate isoprene), poly(ethylacrylate isoprene), poly(propylacrylate isoprene), poly(butylacrylate isoprene), poly(styrenebutadiene acrylic acid), poly(styrenebutadiene methacrylic acid), polyethylene terephthalate, polypropylene terephthalate, polybutylene terephthalate, polypentylene terephthalate, polyhexylene terephthalate, polyheptadene terephthalate, polyoctalene terephthalate, and the like.

The charge control agent controls the amount of electric charge electrified in the toner particles so that the toner particles efficiently form an image.

The toner composition generally includes a releasing agent as a functional additive. The releasing agent improves release of the toner composition from a roller to the recording medium when the toner image is transferred and fixed on the recording medium. Hence, toner offset may be prevented and jamming of the recording medium on the roller caused by the toner composition may be reduced. Lubricants or waxes are generally used for the releasing agent. The toner composition is prepared by grinding or polymerizing the above described ingredients.

During the preparation of conventional toner particles using a latex resin and a wax as the releasing agent, the toner particles include a coloring agent, a charge control agent, the latex resin and the wax. The latex resin and the wax coagulate with other particles to form the toner particles. Since a heating process is required during coagulation, a wax having a relatively low melting point may not be used in the toner particles. Moreover, the particles do not coagulate sufficiently.

U.S. Pat. No. 6,120,967 discloses a method for the preparation of a toner composition. According to the method, a wax emulsion and latex are formed respectively. The wax emulsion and the latex are mixed and a coagulating agent is added to the mixture. The toner particle has a size of about 5 μm to about 15 μm. Polyaluminum chloride is used as the coagulating agent. In this method, however, heterogeneous particles do not coagulate sufficiently when the wax emulsion and the latex are coagulated by the coagulating agent. Additionally, a heating process is required during the coagulating process, and therefore a wax having a relatively low melting point cannot be used effectively.

In the method disclosed in U.S. Pat. No. 6,506,532, a wax emulsion is prepared. The wax emulsion is mixed with a monomer mixture and then polymerized. A toner particle is prepared without using a coagulating agent. In this method, a cationic surfactant is used for the polymerization of the wax emulsion and the monomer mixture, which is expensive and also reduces dispersing effects.

When a commercial wax is used as the releasing agent, the selection of the wax or emulsifier is limited and the formation of the composition tends to be difficult. Since the melting point of the commercial wax cannot be adjusted, the fixing temperature of the image forming device may not be adjusted.

When preparing a wax emulsion individually, a solid wax should be dispersed in water. Thus, a temperature higher than the melting point of the wax is required, and a high speed dispersing device should be employed. In addition, the preparation process becomes complicated.

### SUMMARY OF THE INVENTION

The present invention has been developed in order to solve the above drawbacks and other problems associated with the conventional toner compositions and binding agents for use in toner compositions.

The present invention provides a core-shell latex polymer having a crystalline polymer as the core of the latex polymer. The core-shell latex polymer is used as a binder in toner compositions. The binding property between the crystalline polymer and latex polymer is improved, and the fixing temperature of the toner may be reduced compared to the conventional toner compositions.

The present invention also provides a method of preparing the core-shell latex polymer. The core-shell latex polymer includes a crystalline polymer as the core and is suitable as a binder in toner compositions. The core-shell latex polymer is produced as particles having a particle size sufficient for use as a binder in a toner composition.

One aspect of the present invention is to provide a core-shell latex polymer having a crystalline polymer in the core. The core-shell latex polymer comprises the crystalline polymer, a base monomer, a dispersing agent, an initiator and distilled water. More specifically, the core-shell latex polymers are in the form of particles having a core of a crystalline polymer and a shell produced by polymerizing a base monomer on the core. The base monomer is polymerized in the presence of particles of the crystalline polymer to form the shell encapsulating the crystalline polymer core. The reaction mixture comprises the particles of the crystalline polymer, base monomer, dispersing agent and polymerization initiator. Preferably, the reaction components are dispersed in distilled water. The reaction mixture is polymerized to form the core-shell latex polymer particles.

The base monomer comprises at least one monomer component selected from the group consisting of styrene, divinyl benzene, n-butyl acrylate, methacrylate and acrylic acid.

The crystalline polymer is obtained from a polymerization reaction of a crystalline monomer. The crystalline monomer has at least 18 carbon atoms and a melting point of about 30° C. to about 70° C.

The crystalline polymer is present in the core-shell latex polymer in an amount of from about 1 PHR to about 50 PHR (parts per hundred parts of resin by weight). The resulting core-shell latex polymer has a particle size of about 0.2 μm to about 5 μm.

The initiator comprises at least one component selected from the group consisting of ammonium persulfate, potassium persulfate, benzoyl peroxide and lauryl peroxide.

Another aspect of the present invention is to provide a method of preparing a core-shell latex polymer having a crystalline polymer core. According to the method of the invention, a mixture of an aqueous phase, and a first organic phase including a crystalline monomer and an initiator is polymerized to form the crystalline polymer. The crystalline polymer is typically in the form of particles. The aqueous phase includes a dispersing agent and distilled water. A mixture of a second organic phase including a base monomer, a first aqueous phase, a second aqueous phase and an initiator is polymerized to produce the core-shell latex polymer. The first aqueous phase includes a dispersing agent and distilled water, and the second aqueous phase includes the crystalline polymer and distilled water. An initiator is generally included in the second aqueous phase.

In one embodiment, the crystalline polymer is obtained by polymerizing the reaction mixture containing crystalline monomer at a temperature of about 50° C. to about 80° C.

The crystalline polymer is obtained in the form of particles having a particle size of about 0.05 μm to about 3 μm.

The base monomer used to form the core-shell latex polymer particles is a monomer selected from the group consisting of styrene, n-butyl acrylate, methacrylate, acrylic acid and divinyl benzene.

### DETAILED DESCRIPTION OF THE EXEMPLARY EMBODIMENTS

A latex polymer including a crystalline polymer according to the present invention may be used as a binder resin in a toner composition. Generally, latex, natural or synthetic polymer particles having a size up to about 1 μm are dispersed in a solvent to form two systems. In order to form the latex polymer, a monomer, a surfactant, an initiator, etc may be emulsion polymerized. In the emulsion polymerization, the surfactant itself forms a micelle, which is a small colloidal particle, when the concentration of the surfactant is more than a specific value in an aqueous phase including the monomer or a polymer, the surfactant, the initiator, and other components of the reaction mixture. In a typical emulsion polymerization, the initiator is radicalized in the aqueous phase, and the radical combines with the monomer that is encapsulated in the micelle.

The term “core-shell latex polymer” used in the present invention means polymer particles where each core of a discrete particle is encapsulated within a shell. The core-shell latex polymer according to the present invention includes the crystalline polymer as the core. A base monomer is polymerized with the crystalline polymer core to form the shell encapsulating the crystalline polymer core.

A crystalline monomer, which constitutes the monomer to form the core of the core-shell latex polymer according to the present invention, is preferably selected from a monomer having at least 18 carbon atoms and a melting point of about 30° C. to about 70° C. The melting point and the carbon content of the crystalline monomer tend to determine the melting point of the crystalline polymer. Thus, the range of melting point of the crystalline monomer is selected in order to obtain the desired melting point of the crystalline polymer.

The preferred melting point of the crystalline polymer is generally determined depending upon the desired characteristics of an imaging process in an image forming device using a toner. The desired melting point of the crystalline polymer also depends on the storage stability of the toner, dispersion stability, developing characteristics, transferring ability, fixing ability and strength of a printed image. When the melting point of the crystalline polymer is relatively high, a lot of energy is needed for fixation and the pre-heating time may increase. Thus, the crystalline polymer used as a releasing agent in an electrophotographic image forming device preferably has a low melting point. The melting point of the crystalline polymer may be adjusted in accordance with various electrophotographic image forming devices using the crystalline polymer. In one preferred embodiment, the crystalline polymer has a melting point of about 50° C. to about 80° C.

The crystalline monomer for the crystalline polymer preferably has at least 18 carbon atoms. Octadecyl acrylate (ODA) and behenyl acrylate (BHA) are preferable. Examples of the crystalline monomer that can be used in the present invention include, but are not limited to, stearyl acrylate, stearyl methacrylate, hexadecyl acrylate, hexadecyl methacrylate, heptadecyl acrylate, heptadecyl methacrylate, nonadecyl acrylate, nonadecyl methacrylate, arachyl acrylate, arachyl methacrylate, behenyl methacrylate, pentacosyl acrylate, pentacosyl methacrylate, heptacosyl acrylate, heptacosyl methacrylate, and octadecyl methacrylate. It is understood that these monomers are exemplary and that other monomers can be used.

The crystalline polymer, which serves as the core, is preferably present in the core-shell latex polymer in an amount of from about 1 PHR to about 50 PHR. As used herein, the term PHR refers to parts per hundred parts of resin by weight. The resin refers to the shell of the core-shell latex polymer particles. When the content of the crystalline polymer is less than 1 PHR, the ability of the core-shell latex polymer to function as a releasing agent is poor. When the content of the crystalline polymer is more than 50 PHR, the fixing ability of an image forming device using a toner including the core-shell latex polymer is deteriorated and an image may not be properly formed.

The crystalline monomer is polymerized to form the crystalline polymer that is used as the particle core. An aqueous phase including a surfactant and distilled water is prepared. An organic phase including the crystalline monomer is prepared. The aqueous phase and the organic phase are combined to form a mixture. An initiator to initiate the polymerization reaction is added to the resulting mixture, resulting in the production of the crystalline polymer.

In one embodiment, the organic phase is produced by heating and melting about 10 g to about 40 g of the crystalline monomer. The term, “crystalline monomer” means that the monomer has a specific melting point range and can be polymerized to form a polymer. A surfactant incorporated into distilled water is melted by heating to prepare the aqueous phase. Deionized water bubbled with a nitrogen gas is deoxygenated to prepare the distilled water.

The aqueous phase and the organic phase are incorporated into a 1 l reactor, mixed and then homogenized using a homogenizer. The resulting homogenization process is preferably conducted for about 1 to about 10 minutes at speeds of about 1,000 RPM to about 7,000 RPM. The term “RPM” refers to revolutions per minute. The resulting homogenized solution is put into a water bath. The homogenized solution is then heated to a temperature of about 50° C. to about 80° C. in the homogenizer at speeds of about 100 RPM to about 800 RPM. When the temperature of the water bath reaches the desired temperature, the initiator is added to the homogenized solution to initiate a polymerization reaction. The water bath is purged with a nitrogen gas. The polymerization reaction is conducted for about 5 to about 24 hours. After the reaction is completed, the resultant solution is cooled down at room temperature. The cooled solution is stored in a 1 l sample bottle.

The polymerization reaction is conducted at a temperature higher than the melting point of the crystalline monomer. The polymerization temperature of the crystalline monomer is higher than the melting point of the crystalline monomer. Thus, the temperature of the polymerization reaction will vary depending on the melting point of the selected crystalline monomer and the content thereof.

The crystalline polymer obtained by the above process is polymerized with a base monomer to produce the core-shell latex polymer having a core formed by the crystalline polymer and a shell formed by the polymer obtained by polymerizing the base monomer.

Examples of the base monomer used to produce the core-shell latex polymer according to the present invention include, but are not limited to, styrene, divinyl benzene, n-butyl acrylate, (meth)acrylate and acrylic acid. These can be used alone or as a mixture thereof. In further embodiments, the base monomer that can be used in the present invention, include, for example, methyl acrylate, ethyl acrylate, methyl (meth)acrylate, isobutyl (meth)acrylate, isodecyl (meth)acrylate, cyclohexyl (meth)acrylate, vinyl ester, dicyclopentenyl (meth)acrylate, norbornyl (meth)acrylate, isobornyl (meth)acrylate, acrylic (meth)acrylic acid, hydroxyalkyl (meth)acrylate, N-alkylacryl amide, N,N-dialkylamino monoalkyl (meth)acrylate, N-alkylaminoalkyl (meth)acrylate, hydroxyethyl acrylate, N-methylacrylamide, n-butylmethacrylamide, N-methylolacrylaminde, N-butylaminoethyl (meth)acrylate, N,N′-diethylaminoethyl (meth)acrylate, N,N′-dimethylaminoethyl (meth)acrylate, isobutoxy(meth)acrylamide, and the like. These base monomers can be used alone or as mixtures thereof.

The dispersing agent may be classified into an anionic surfactant, a cationic surfactant and a non-ionic surfactant. The anionic surfactants and the non-ionic surfactants are advantageously used in the present invention. Examples of anionic surfactants which can be used in the present invention may include, but are not limited to, sodium dodecylsulfate (SDS), sodium dodecylbenzenesulfonate, sodium dodecylnaphthalenesulfate, dialkyl benzenealkyl, sulfates, sulfonates, and the like. Examples of non-ionic surfactants which can be used in the present invention may include, but are not limited to, polyvinyl alcohol, polyacrylic acid, methyl cellulose, ethyl cellulose, propyl cellulose, hydroxyethyl cellulose, carboxymethyl cellulose, polyoxyethylene cetyl ether, polyoxyethylene lauryl ether, polyoxyethylene octyl ether, polyoxyethylene octylphenyl ether, polyoxyethylene stearyl ether, polyoxyethylene nonylphenyl ether, ethoxylate, phosphated nonylphenol based serboxyl such as DPNZ 20/100 or Triton, dialkylphenoxypoly(ethyleneoxy)ethanols such as products sold under the name IGEPAL CA-210™, IGEPAL CA-520™, IGEPAL CA-720™, IGEPAL CO-890™, IGEPAL CO-720™, IGEPAL CO-290™, ANTAROX 890™ and ANTAROX 897™ by the company Rhone-Poulenc (France), and the like. These can be used alone or as mixtures thereof.

As the term is used in the specification, the meaning of the dispersing agent is substantially equal to that of the surfactant. The dispersing agent may be present in two reaction phases to form polymer particles.

The initiator is added to the reaction mixture to initiate the polymerization reaction. The initiator is classified as a water soluble initiator or a fat soluble initiator. Either the water soluble initiator or the fat soluble initiator may be used in the present invention.

Examples of initiators which can be used in the present invention may include, but are not limited to, potassium persulfate, ammonium persulfates, benzoyl peroxide and lauryl peroxide. These can be used alone or as a mixture thereof.

In other embodiments of the invention, the initiators which can be used in the present invention can also be sodium persulfate, hydrogen peroxides, t-butyl hydroperoxide, cumene hydroperoxide, para-menthane peroxides, peroxy carbonates, and the like. These can be used alone or as mixtures thereof.

Since the initiator determines the melting point of the crystalline polymer, it is preferable to select the initiator according to the desired melting point of the crystalline polymer, and to select the crystalline monomer and the content thereof according to the desired properties of the resulting crystalline polymer.

The initiator can be added to the monomer mixture at various stages to achieve the desired properties in the resulting polymer. The initiator can be added to the reaction vessel before the monomer is dropped, during the dropwise addition of the monomer or after the dropwise addition of the monomer. The initiator is preferably used in an amount of from about 1 PHR to about 5 PHR. The content of the initiator is determined depending on the content of the crystalline monomer and the base monomer.

Hereinafter, a method of preparing a core-shell latex polymer including the above described crystalline polymer as a core will be described in detail.

An organic phase including a base monomer is prepared. When the base monomer is a monomer mixture, two kinds of base monomers are mixed at a specific ratio to prepare the organic phase. A dispersing agent is dissolved in distilled water by heating to prepare a first aqueous phase. As described in the preparation of the crystalline polymer, the deionized water is used as the distilled water. One or more of the above mentioned anionic or non-ionic surfactants may be used as the dispersing agent. The first aqueous phase and the organic phase are added to a 1 l reactor. The first aqueous phase and the organic phase are mixed and then homogenized using a homogenizer. The homogenization process is conducted for about 1 to about 10 minutes at speeds of about 1,000 RPM to about 7,000 RPM.

The crystalline polymer obtained above is mixed with deionized water to prepare a second aqueous phase. The second aqueous phase is put into a water bath. The mixture of the first aqueous phase and the organic phase is added to the water bath, and then heated at a temperature of about 50° C. to about 80° C. with stirring at speeds of about 100 to about 800 RPM. When the water bath reaches the desired temperature, an initiator is added to the water bath. The water bath is purged with a nitrogen gas. The polymerization reaction is conducted for about 5 to about 24 hours. After the reaction is completed, the resultant solution is cooled down to room temperature. The cooled solution is stored in a 1 l sample bottle.

The core-shell latex polymer prepared by the above described method has a particle size of about 0.2 μm to about 5 μm. The core-shell latex polymer includes the crystalline polymer which acts as a releasing agent. A toner using the core-shell latex polymer according to the present invention as a binder resin improves the fixing ability of the toner and prevents off-set thereof.

The following examples further describe and demonstrate embodiments within the scope of the present invention. The examples are given solely for the purpose of illustration and are not to be construed as limitations of the present invention, as many variations thereof are possible without departing from the spirit and scope of the invention.

### EXAMPLES

### Example 1

Preparation of a Crystalline Polymer

100 g of octadecyl acrylate was melted by heating to prepare an organic phase. 1.5 g of an anionic surfactant and 1.5 g of a nonionic surfactant were dissolved in 200 g of deionized water to prepare an aqueous phase. The organic phase and the aqueous phase were incorporated into a 1 l reactor, mixed and then homogenized using an IKA Ultra Turrex homogenizer to obtain a homogenized mixture. The homogenization process was conducted for 10 minutes at a speed of 7000 RPM.

The homogenized mixture was put into a water bath, and then heated to a temperature of 60° C. while stirring at a speed of 100 RPM. When the internal temperature of the water bath reached 60° C., ammonium persulfate as an initiator was added to the mixture. The water bath was purged with a nitrogen gas. The reaction was maintained for 7 hours to produce a crystalline polymer. After the reaction was completed, the resulting solution was cooled down to room temperature.

The melting point of the resulting crystalline polymer was measured using a differential scanning calorimeter(DSC). The crystalline polymer had a melting point of 50° C.

Preparation of a Core-Shell Latex Polymer

30 parts by weight of styrene, 8 parts by weight of butyl acrylate and 2 parts by weight of acrylic acid were mixed to prepare an organic phase. 1 part by weight of Triton as a dispersing agent was dissolved in 100 parts by weight of deionized water to prepare a first aqueous phase. The organic phase and the first aqueous phase were mixed and then homogenized using an IKA Ultra Turrex homogenizer to obtain a homogenized solution. The homogenization process was conducted for 5 minutes at speeds of 7,000 RPM.

15 parts by weight of the resulting crystalline polymer emulsion and 100 parts by weight of deionized water were mixed to prepare a second aqueous phase. The second aqueous phase was mixed with the homogenized solution to form a reaction mixture. The reaction mixture was put into a water bath. The reaction mixture was then heated to a temperature of 80° C. while stirring at a speed of 150 RPM. When the internal temperature of the water bath reached 80° C., 2 parts of a polymerization initiator was added to the reaction mixture. The water bath was purged with a nitrogen gas. The reaction was maintained for 3 hours to produce the core-shell latex polymer. After the reaction was completed, the resulting solution was cooled down to room temperature.

The resulting core-shell latex polymer had a spherical average size of 2.6 μm.

### Example 2

Preparation of a Crystalline Polymer

The procedure of Example 1 was repeated except that behenyl acrylate was used instead of octadecyl acrylate to prepare the crystalline polymer.

The melting point of the resulting crystalline polymer was measured using a DSC. The crystalline polymer had a melting point of 63° C.

Preparation of a Core-Shell Latex Polymer

The procedure of Example 1 was repeated except that the crystalline polymer produced from behenyl acrylate was used to prepare a core-shell latex polymer.

The obtained core-shell latex polymer had a spherical average size of 3.6 μm.

### Example 3

Preparation of a Crystalline Polymer

The procedure of Example 1 was repeated except that the reaction was maintained for 10 hours instead of 7 hours to prepare the crystalline polymer.

The melting point of the resulting crystalline polymer was measured using a DSC. The crystalline polymer had a melting point of 55° C.

Preparation of a Core-Shell Latex Polymer

The procedure of Example 1 was repeated except that the crystalline polymer prepared by reacting the reaction mixture for 10 hours was used to prepare the core-shell latex polymer.

The obtained core-shell latex polymer has a spherical average size of 3.1 μm.

### Example 4

Preparation of a Crystalline Polymer

The procedure of Example 1 was repeated except that benzoyl peroxide was used instead of ammonium persulfate as the initiator to prepare the crystalline polymer.

The melting point of thus prepared crystalline polymer was measured using a DSC. The crystalline polymer has a melting point of 49° C.

Preparation of a Core-Shell Latex Polymer

The procedure of Example 1 was repeated except that the crystalline polymer obtained by the use of benzoyl peroxide as the initiator was used to prepare a core-shell latex polymer.

The resulting core-shell latex polymer had a spherical average size of 2.9 μm.

As described above, a core-shell latex polymer is produced having a crystalline polymer as a core of the particle. The melting point of the crystalline polymer may be adjusted and selected according to the melting point of the crystalline monomer, the degree of polymerization and the initiator. When the core-shell latex polymer is used in a toner of an image forming device, the fixing temperature of the toner can be reduced to save energy. Furthermore, the pre-heating time of the toner may be reduced. In addition, the core-shell latex polymer including the crystalline polymer according to the present invention does not use an individual wax. Since a polymerization reaction is preformed instead of a coagulation process that is hard to control, the crystalline polymer as the releasing agent may be produced without using a high temperature and high speed dispersing device. Moreover, a particle size and a distribution thereof of a toner particle may be reduced.

In this description, various examples and embodiments have been selected to illustrate the invention. It will be understood that various changes and modifications can be made without departing from the scope of the invention as defined in the appended claims.

1. A core-shell latex polymer having a core formed from a crystalline polymer, where said core-shell latex polymer is produced by polymerizing a mixture comprising:
said crystalline polymer;
a base monomer;
a dispersing agent;
an initiator; and
distilled water.

2. The core-shell latex polymer according to claim 1, wherein the base monomer comprises at least one selected from the group consisting of styrene, divinyl benzene, n-butyl acrylate, methacrylate and acrylic acid.

3. The core-shell latex polymer according to claim 1, wherein the crystalline polymer is obtained from a polymerization of a crystalline monomer.

4. The core-shell latex polymer according to claim 3, wherein the crystalline monomer has a melting point of about 30° C. to about 70° C. and has at least 18 carbon atoms.

5. The core-shell latex polymer according to claim 1, wherein the crystalline polymer is present in the core-shell latex polymer in an amount of from about 1 PHR to about 50 PHR.

6. The core-shell latex polymer according to claim 1, wherein the latex polymer has a particle size of about 0.2 μm to about 5 μm.

7. The core-shell latex polymer according to claim 1, wherein the initiator comprises at least one selected from the group consisting of ammonium persulfate, potassium persulfate, benzoyl peroxide and lauryl peroxide.

8. A method of preparing a core-shell latex polymer having a crystalline polymer core, comprising:
mixing and polymerizing an aqueous phase including a dispersing agent and distilled water, with a first organic phase including a crystalline monomer and an initiator to form the crystalline polymer; and
mixing and polymerizing a second organic phase including a base monomer, a first aqueous phase including a dispersing agent and distilled water, a second aqueous phase including said crystalline polymer and distilled water and an initiator to produce said core-shell latex polymer.

9. The method as claimed in claim 8, comprising polymerizing said aqueous phase with said first organic phase to form said crystalline polymer at a temperature range of about 50° C. to about 80° C.

10. The method as claimed in claim 8, wherein said crystalline polymer has a particle size in the range of about 0.05 μm to about 3 μm.

11. The method as claimed in claim 8, wherein the base monomer comprises at least one selected from the group consisting of styrene, n-butyl acrylate, methacrylate, acrylic acid and divinyl benzene.

12. Core-shell latex polymer particles as a binder resin in a toner composition, said core-shell latex polymer particles comprising;
a crystalline polymer core obtained from the polymerization of a crystalline monomer; and
a shell encapsulating said core, where said shell is obtained by the polymerization of a base monomer in the presence of particles of said crystalline polymer.

13. The core-shell latex polymer particles of claim 12, wherein said particles are obtained by polymerizing a mixture of particles of said crystalline polymer, said base monomer, a dispersing agent, a polymerization initiator and distilled water.

14. The core-shell latex polymer particles according to claim 12, wherein the base monomer comprises at least one selected from the group consisting of styrene, divinyl benzene, n-butyl acrylate, methacrylate and acrylic acid.

15. The core-shell latex polymer according to claim 12, wherein the crystalline monomer has a melting point of about 30° C. to about 70° C. and has at least 18 carbon atoms and where said particles of said crystalline polymer have a particle size of about 0.2 μm to about 5 μm.

16. The core-shell latex polymer according to claim 12, wherein the crystalline polymer is present in the core-shell latex polymer in an amount of from about 1 PHR to about 50 PHR.

17. The core-shell latex polymer according to claim 13, wherein the initiator comprises at least one selected from the group consisting of ammonium persulfate, potassium persulfate, benzoyl peroxide and lauryl peroxide.

18. A binder for a toner composition, where said binder is core-shell latex polymer particles comprising:
a crystalline polymer core; and
a shell encapsulating said core and being obtained by the polymerization of a base monomer in the presence of particles of said crystalline monomer.

19. The binder of claim 18, wherein said core-shell latex polymer particles are obtained by polymerizing a mixture of particles of said crystalline polymer, said base monomer, a dispersing agent, a polymerization initiator and distilled water.

20. The binder according to claim 19, wherein the base monomer comprises at least one selected from the group consisting of styrene, divinyl benzene, n-butyl acrylate, methacrylate and acrylic acid.

21. The binder according to claim 19, wherein the crystalline monomer has a melting point of about 30° C. to about 70° C. and has at least 18 carbon atoms and where said particles of said crystalline polymer have a particle size of about 0.2 μm to about 5 μm.

22. The binder according to claim 19, wherein the crystalline polymer is present in the core-shell latex polymer in an amount of from about 1 PHR to about 50 PHR.

23. The binder according to claim 19, wherein the initiator comprises at least one selected from the group consisting of ammonium persulfate, potassium persulfate, benzoyl peroxide and lauryl peroxide.
